(19) United States
(12) Patent Application Publication
(10) Pub. No.: US 2004/0254682 A1
(43) Pub. Date: Dec. 16, 2004

(54) Apparatus, system and method for non-chemical treatment and management of cooling water

(76) Inventor: Tim Kast, Golden, CO (US)

Correspondence Address: JOHN R. POSTHUMUS, ESQ., REG. NO. 36,245, GREENBERG TRAURIG, LLP, 1200 SEVENTEENTH STREET, SUITE 2400, DENVER, CO, 80202, US

(21) Appl. No.: 10/330,839

(22) Filed: Dec. 27, 2002

Related U.S. Application Data
(60) Provisional application No. 60/344,282, filed on Dec. 27, 2001.

(51) Int. Cl. G05B 21/00

(52) U.S. Cl. 700/265

(57) ABSTRACT

An apparatus, system and method of providing non-chemical cooling water treatment and management is disclosed. The invention combats the problems of scaling, microbiological growth, corrosion and fouling. The overall system is regulated by a monitoring and control system that allows for full management of cooling water treatment. Without the use of chemicals, the system and method of the present invention is an effective, safe and environmentally sound approach to the treatment of cooling water.

### RELATED APPLICATION

This application claims priority from U.S. Provisional Application Ser. No. 60/344,282, filed on Dec. 27, 2001, which is incorporated herein by reference.

### FIELD OF INVENTION

The present invention relates generally to the field of cooling water treatment. More specifically, the invention relates to a comprehensive system for non-chemical treatment and management of cooling water. The invention includes a water management system designed to control scale, microbiological growth, corrosion and fouling, as well as provide overall system control, on-site and remote monitoring, and alarm capabilities.

### BACKGROUND OF INVENTION

Cooling water systems require various treatments to prevent scaling and depositing, corrosion, and microbiological fouling. In the past, chemicals have typically been used for treatments. However, environmental pressures are abundant and there is a need for a safer, more environmentally sound method of treating cooling water. Furthermore, the treatment must be as effective as current treatments without losing any process efficiency.

Previously, companies have applied individual non-chemical components or have integrated separate solutions to cooling water treatment, often in conjunction with traditional chemical treatment. These combinations are often incompatible and are, therefore, less effective than desired. Thus, there is a need for a non-chemical treatment that are compatible as a system and result in more efficient water treatment.

### SUMMARY OF INVENTION

The present invention satisfies, to a great extent, the foregoing and other needs not currently satisfied by existing systems. It is a comprehensive water treatment system that is comprised of separate non-chemical components that are regulated through a microprocessor-based cooling water control system that allows for continuous on-site and/or remote monitoring and control of key system parameters and water treatment equipment.

In a preferred embodiment, the present invention is comprised of an electronic scale control unit for the prevention and removal of scale, an ionization bio-control unit to kill a wide range of microbiological species evident in cooling water systems, a high-efficiency filtration unit, as well as a sophisticated microprocessor-based cooling water monitoring and control system. Together, these components also contribute to the overall corrosion control program that is necessary in cooling water treatment.

For example, the scale control unit assists in addressing corrosion by maintaining the cooling water in a stable non-corrosive alkaline pH range without any adjustments. The non-corrosive alkaline pH also helps to promote the desired formation of the mineral crystals within the water column instead of on heat exchange surfaces. Furthermore, these suspended scale crystals provide a thin, non-adhering corrosion buffer on all the metallic surfaces throughout the system.

The ionization bio-control unit ensures that harmful bacteria, algae, slime and other microbiological activity in a cooling system remain under control at all times. Low levels of copper and silver ions have been shown to be highly effective against a wide range of micro-organisms, including algae, biofilms and bacteria. By controlling these microbiological populations within the system, additional causes of corrosion are eliminated.

The copper and silver ions are effective at reducing the nutrients available to support microbiological life and penetrating the resilient biofilms that harbor anaerobic bacteria responsible for Microbiological Influenced Corrosion (MIC). Unlike traditional chemicals used to combat these microbiological issues (particularly oxidizers), that are often highly corrosive themselves, the ionization bio-control unit of the present invention achieves superior control of these corrosion-causing micro-organisms without the need for additional corrosion control.

Finally, efficient filtration, preferably through a high-efficiency unit, substantially continually removes the debris scrubbed from the air that provides nutrients that help support microbiological life and causes solid fouling that promotes deposit formation and further corrosion. The filtration unit also removes many of the solid particles formed by the scale control unit, further reducing the potential for fouling and corrosion. However, the filtration unit may be optional.

Together, the combined effects of these components not only limit corrosion within a cooling water system, but also keep the water clean, safe and crystal clear. When coupled with the microprocessor-based monitor and control system, the cooling equipment is well protected from corrosion. In this regard, the present invention comprises not only the selection of the above-mentioned components or technologies, but also the manner in which they are applied within a cooling water system. How each treatment component interacts with the other cooling system elements, localized cooling water conditions, and the other treatment components determines the effectiveness of the combined system. The placement of these individual components within a cooling system as outlined in the present invention contributes to the achievement of the treatment system objectives.

As such, a goal of the present invention is not simply to replace chemicals used to control corrosion, scale and microbiological growth, for example, but to make cooling water perform more efficiently than ever before. Advantages of the present invention include reductions in water use and discharge, increases in energy savings or production, reduced maintenance, and extended equipment life. These and other advantages of the present invention will be further appreciated in light of the following description.

### BRIEF DESCRIPTION OF PREFERRED EMBODIMENTS

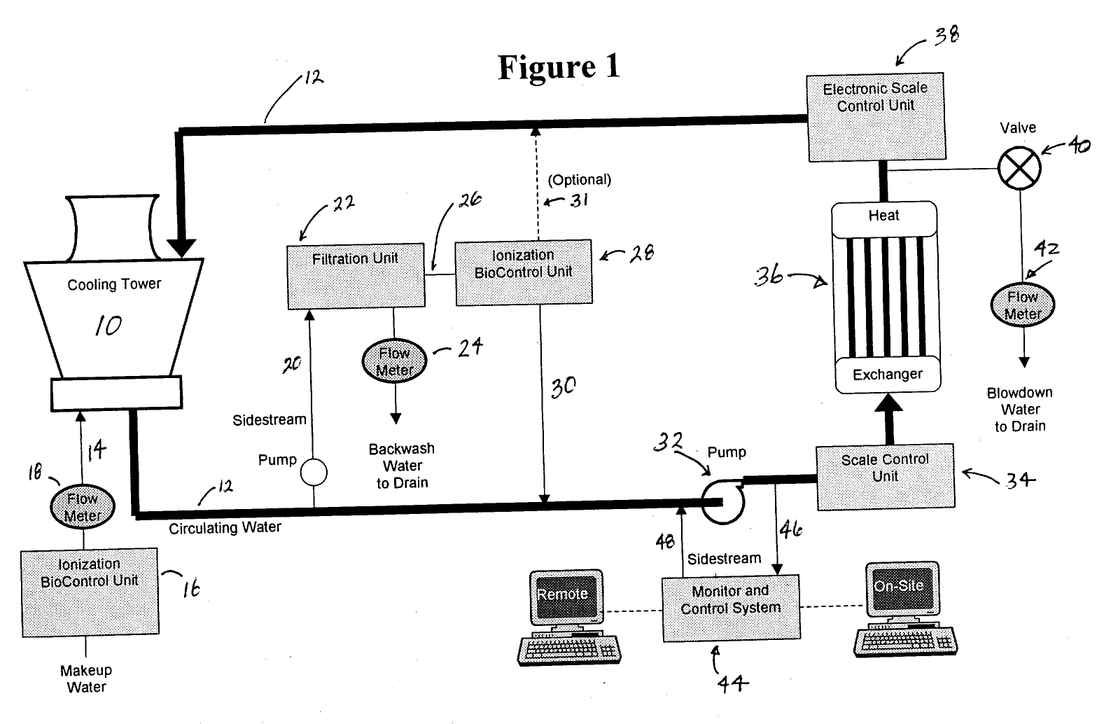

FIG. 1 is a flow diagram of a preferred embodiment of the water treatment system of the present invention.

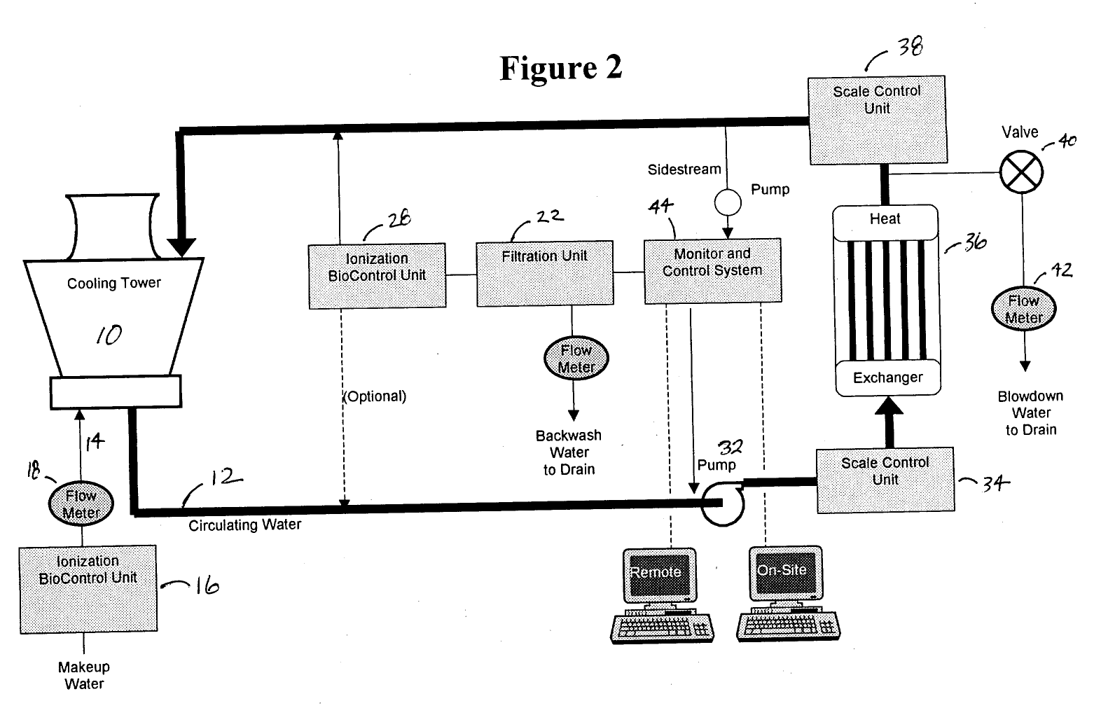

FIG. 2 is a flow diagram of another embodiment of the water treatment system of the present invention.

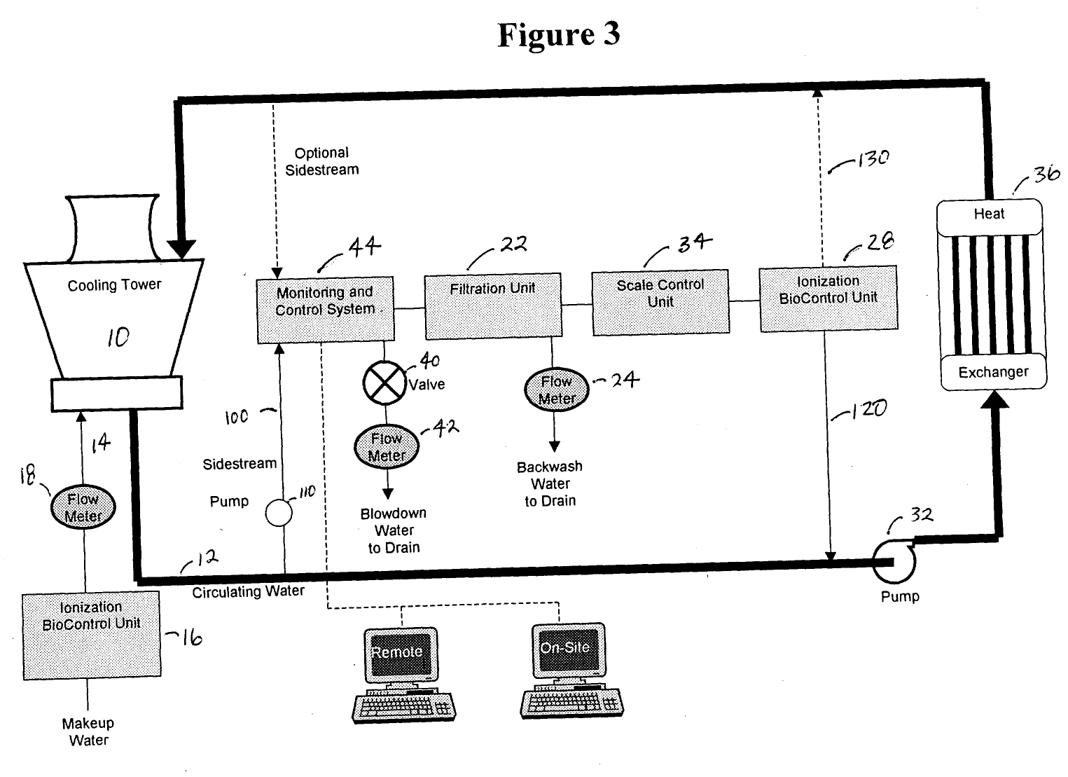

FIG. 3 is a flow diagram of a third embodiment of the water treatment system of the present invention.

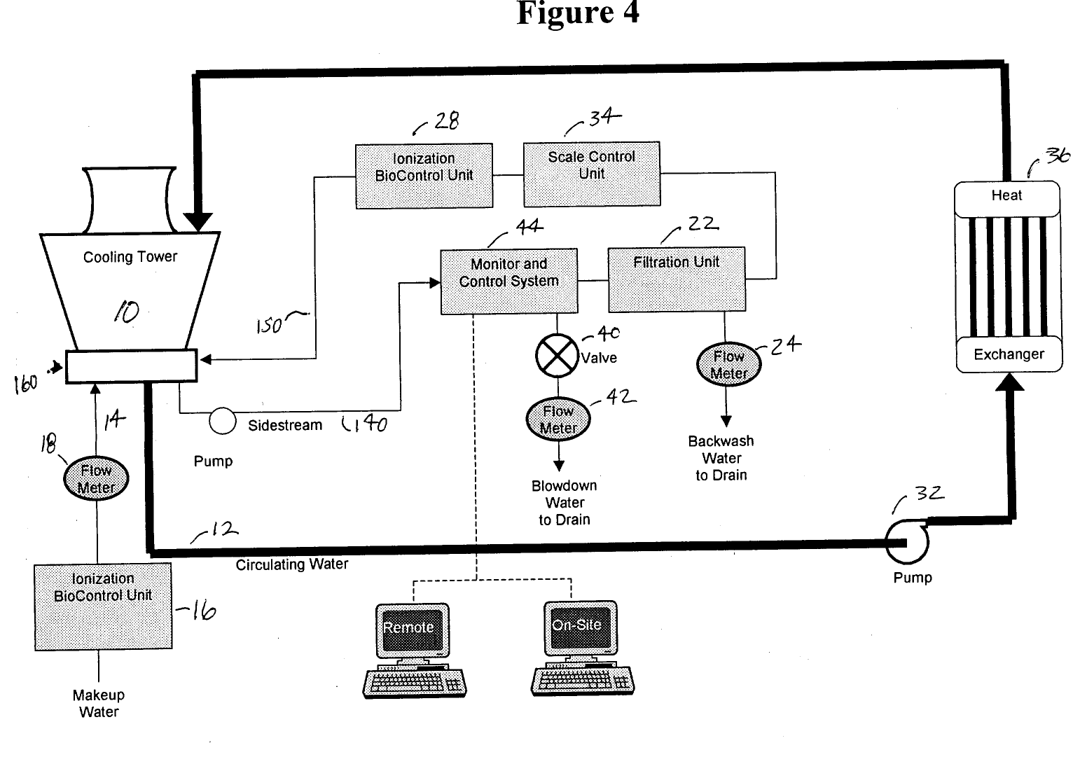

FIG. 4 is a flow diagram of a fourth embodiment of the water treatment system of the present invention.

### DETAILED DESCRIPTION OF PREFERRED EMBODIMENT

The present invention relates generally to the field of cooling water treatment. More particularly, it comprises a system of nonchemical-based components coupled with a microprocessor-based monitor and control system. In a preferred embodiment, the present invention is comprised of an electronic scale control unit, an ionization bio-control unit, a high-efficiency filtration unit, and a monitor and control system. These units will be referred to as system components, water treatment components, treatment and control components, water treatment and management system components, or the like.

Referring now to FIG. 1, there is shown a flow diagram illustrating an arrangement of the cooling water treatment and management system components of the present invention, in accordance with a preferred embodiment of the present invention. The treatment and control components preferably include a plurality of scale control units, a plurality of ionization bio-control units, a filter, a plurality of flow meters, a heat exchanger and a monitor and control system. Alternatively and optionally, the components may include a scale control unit, an ionization bio-control unit, a filter and a monitor and control system. The number and arrangement of the treatment and control components may be increased/decreased or located as necessary to achieve one or more desired water treatment and management objectives.

By way of overview of operation, such as within an evaporative cooling water system, the preferred component arrangement of FIG. 1 allows cooled water to flow from the collection basin of a cooling tower 10 through a pump 32, which in turn pumps the water through a heat exchanger apparatus 36 to be cooled and returned to the cooling tower 10.

More specifically, the cooling water treatment process begins with a small amount of cooling water being evaporated into a stream of air that is induced to flow in direct contact with the falling water within the cooling tower 10 to effect cooling of the circulating water 12, which is represented by the thick black line. The cooling tower 10 is equipped with a makeup water line 14 for accepting makeup water into the cooling tower 10.

In some instances, makeup water is added to the cooling tower 10 to compensate for water lost to evaporation and bleed. Preferably, an ionization bi-control unit 16 is optionally attached to the makeup water line 14 in order to maintain a desired level of ions in the water, so that the water is safe for human consumption. At this location, ion generation may be enhanced by the differences in water quality of the makeup water versus the cooling water. For instance, the makeup water via line 14 has a lower electrode scaling potential so the electrodes remain cleaner.

Also, at this location, the bio-control unit 16 requires specified controls in order to regulate the ion generation process depending on the flow rate of the makeup water. This optional unit 16 may be used in addition or in lieu of the bio-control unit 28, which is located downstream of the filtration unit 22 and upstream of the pump 32. A flow meter 18, is also optionally connected to the makeup flow line 14, operates to facilitate proper flow rate of the makeup water to the cooling tower 10. A more detailed description of the bio-control unit is contained herein.

As the cooled circulating water 12 leaves the cooling tower 10, a portion of a sidestream 20 of the cooled water is filtered using a filtration unit 22. The filtration unit 22, preferably a high-efficiency unit, removes airborne particulate matter scrubbed from the air by the water in the cooling tower 10 along with dead micro-organisms and other coagulated solids that foul cooling water systems.

Removal of particulate matter is performed on a substantially continuous basis. Examples of deposits or suspended solids that are filtered by the filtration unit 22 include calcium carbonate and other scale-forming minerals composed of calcium, magnesium, phosphate, sulfate and silicate. These materials rapidly plug or solidify within a filter. By removing these materials, a significant portion of the nutrients and fouling that encourages micro-biological growth, biofilm formation and corrosion, is eliminated. Furthermore, proper filtration facilitates final removal of many of the waterborne mineral scale crystals formed by the scale control unit 34, which is located downstream of the pump 32.

While any number of conventional filters may be employed in the water treatment arrangement of the present invention, it is preferable to select a filtration unit configured to remove particulate matter above a desired size range, such as 10 microns or above. An advantage of such removal is the tendency of particulate matter to settle out of the water stream in low velocity areas, such as in the basin of the cooling tower 10. In other words, the preferred filtration unit has a low affinity for the precipitated mineral crystals.

In addition, and as depicted in FIG. 1, the preferred filtration unit 22 is configured with a controller (not shown) that regulates all unit operations, including backwash. Proper and frequent backwash of the filtration unit 22 is preferred, where shorter frequent periods are ideal.

During a backwash operation, water is introduced to the bottom of a media bed (not shown) of the filtration unit 22 through an under-drain assembly (not shown). The backwash operation is designed to fulidize the media bed so that mineral deposits are mechanically removed from the media bed's particles themselves. Consequently, filtered contaminants are removed from the top of the unit 22 automatically.

Makeup water is preferably used as the water source for a backwash operation because makeup water generally lowers the pH level within the filtration unit 22 and helps to dissolve any deposited minerals. Further water savings may be achieved by using the sidestream 20 of the cooled water as the backwash water source, as is depicted in FIG. 1.

These backwash methods aid in preventing the media bed's particles from attaching to one another with the mineral crystals. The filtration unit 22 may be set to backwash based on time or differential pressure. In the end, the backwash water is discarded from the filtration unit 22 through an outside drain using a flow meter 24.

As previously described, the filtration unit 22 uses a sidestream 20 of cooled circulating water 12 to remove suspended particulate matter from the water 12 on an ongoing basis. The quantity of the sidestream 20 is best represented by a flow percentage. That is, the flow of the sidestream 20 into the filtration unit 22 is approximately three (3) to ten (10) percent of the overall flow of the cooled water 12; these percentage figures significant impacts the capacity of the cooling tower 10, the heat exchanger apparatus 36, or both.

The continuous movement or flow of the sidestream 20 is accomplished by a pump (not shown), which is preferably located within the filtration unit 22. Alternatively and optionally, the pump may be located outside the filtration unit 22. In addition, the sidestream 20 may alternatively return to the flow of circulating water 12 just downstream of where it was drawn off, as at 20. If this flow were allowed to bridge from the hot to the cold locations within the cooling water piping, or vice versa, the thermal efficiency of the cooling system would be reduced. The cold location is the line 30 from the ionization biocontrol unit 28. The hot location is the line 31 from the ionization biocontrol unit 28.

As depicted in FIG. 1, the filtration unit 22 is preferably located downstream of the cooling tower 10 and upstream of the heat exchanger apparatus 36, so that it filters the coolest circulating water 12 with the lowest scaling potential. Another advantage of this configuration is that it provides for the most efficient removal of suspended particulate matter on a per pass basis. Yet another advantage of this configuration is that it helps provide the cleanest possible water flowing through the entire cooling system and over the cooling tower 10.

While the high-efficiency filtration unit 22 helps each of the other water treatment components work more efficiently, the unit 22 is not mandatory. The water treatment and management system of the present invention may operate without a filtration unit 22, such that unit 22 is an optional component. A result of omission of the filtration unit 22 may be more frequent manual cleaning of low velocity zones, such as tower 10 basins and strainers, where solid precipitates are likely to accumulate. These precipitates may be removed by routine blowdown. Smaller cooling systems, in particular, may be less dependent on filtration unit(s). The preferred embodiment of the present invention includes one or more filtration units for cooling systems of all sizes.

It is important to observe the connection between the filtration unit 22 and an ionization bio-control unit 28. A portion of the sidestream 20 that flows into the filtration unit 22 also flows, as at 26, into the ionization bio-control unit 28 where it is used for ion generation. The bio-control unit 28 generates silver and copper ions in a controlled manner to act as a potent but safe biocide against a wide range of micro-biological species in the cooling system. In this regard, the bio-control unit 28 operates to eliminate the need for halogen-based, or other toxic, biocides and the corrosion they promote, by employing silver and copper ions.

More specifically, the ionization bio-control unit 28 maintains a precise but very low residual of metal ions in the circulating water 12 that is lethal to microbiological life but below levels considered healthy for human drinking water. This is preferably accomplished by employing within the unit 28, an electrolytic cell with alternating polarity direct current across a series of electrodes made of specially alloyed silver and copper. The electrodes are housed in a flow cell that allows for the proper positioning and spacing of the electrodes.

As the sidestream 26 of cooled water 12 (or makeup water) flowing from the filtration unit 22 passes by the bio-control unit's electrodes, an applied electrical potential causes chemical reactions to take place on the electrode surface. These chemical reactions essentially represent the controlled corrosion of the electrodes so that a small and precise amount of silver and copper ions are released into the water.

The silver and copper ions produced provide residual disinfection advantage throughout the entire cooling water system when the sidestream 30 containing the silver and copper ions is injected back into the cooling system, as at 30. Noteworthy is the fact that disinfection occurs throughout the cooling system, not just at the point of treatment of injection, as is the case with other non-chemical technologies.

As depicted in FIG. 1, the flow of copper and silver ion-rich water is injected upstream of the heat exchanger apparatus 36. However, the bio-control unit's sidestream 30 flow may be injected back into the cooling system at another location as desired, such as prior to the cooling tower 10 and/or into the collecting basin of the cooling tower 10. Selection of an injection location that may be deemed desirable depends in part on the specific micro-biological problems to be addressed and/or the effects of other treatment components. The effects of other treatment components may in turn be dependent on makeup water chemistry and system operating conditions.

Preferably, as shown in FIG. 1, placement of the ionization bio-control unit 28 upstream of the heat exchanger apparatus 36 and downstream of the filtration unit 22 is advantageous in part because this location allows the bio-control unit 28 to use the coolest water in the system, a use that promotes effective ion generation. Also, the bio-control unit 28 is preferably configured with a microprocessor-based controller (not shown) that facilitates remote control and monitoring of the ion generation process.

Once the sidestream 30 containing copper and silver ion-rich water is injected into the circulating water 12, the water is pumped, via pump 32, into a non-chemical scale control unit 34, which is downstream from a heat exchanger apparatus 36. The scale control unit 34 may be selected from several different types known in the art that have the effect of creating electrical fields within water to induce molecular agitation of the dissolved solids. The molecular agitation results in controlled precipitation or crystal modification of the scale-forming mineral salts, which then prevents deposition onto the heat exchange surfaces.

A preferred embodiment of the scale control unit 34 is electronic and described in more detail below. Other embodiments that effect the same result for producing electrical fields within water is understood to be included in the present invention. In the preferred embodiment, the desired molecular agitation effect is based upon the electronically controlled electromagnetic generation of electrical fields.

Similarly, the heat exchanger apparatus 36 may be selected from several types known in the art. It may be any unit designed to transfer heat to cooling water, such as a heat exchanger, condenser, or other such mechanical device.

The internal configuration of the scale control unit 34 includes an electronic current driver circuitry that supplies a direct current of alternating polarity to an electromagnetic radiating device, such as a solenoid coil. The coil is installed near a conduit or vessel, such as a pipe, that holds the water to be treated. The pipe is submerged within the cooling water. The polarity of the coil is changed rapidly to effectively treat the water that passes by the coil or electromagnetic radiation device. This rapid change in current creates an electrical field within the water that alternates in direction as the current polarity changes. Positively and negatively charged ions within this field, including scale-forming cations (Ca++) and anions (HCO₃⁻), are forced to move in opposite directions along the electrical field lines. This movement of the scale-forming cations and anions causes energetic collisions of these oppositely charged ions.

Ionic collisions lead to successful formation of viable clusters or nuclei of scale-forming salts that are produced in solution rather than on the surfaces of the heat exchanger apparatus 36. Within regions of the cooling water system where scale would normally form, precipitation preferentially takes place on these nuclei rather than on heat transfer surfaces. The crystals formed by controlled precipitation of the scale control unit 34, have a non-adhering or amorphous crystal structure that differs from the typical hard, adherent scale found on the tubes of the heat exchanger apparatus 36. These non-adhering mineral crystals continue to grow until they reach a size where they can be filtered or settle in low velocity areas of the cooling water system.

The end result is the continuous removal of hardness from the water (i.e. water softening) in the cooling tower 10 by the scale control unit 34 without the need for chemicals, resin regeneration, salt, or wasted water. The unit 34 only removes unwanted impurity leaving all of the water behind. In addition, the surfaces of the heat exchanger apparatus 36 remain clean, and existing scale is removed from the system. Further, since the electronic scale control unit 34 softens the water, it also allows the cooling system to operate at higher than normal cycles of concentration, thereby reducing water discharge and makeup water requirements.

Circulating water 12 exiting the heat exchanger apparatus 36 may be treated by another optional scale control unit 38 located between the heat exchanger apparatus 36 and the cooling tower 10. The optional scale control unit 38 may be substantially identical to the scale control unit 34 described above, but may be added to help protect the cooling tower 10 from various scale-forming constituents that may preferentially form there.

A specified amount of circulating water 12 exiting the heat exchanger apparatus may also be removed as bleed, or blowdown, in order to keep levels of non-evaporated solids in the cooling system within acceptable limits. An automatic or manual valve 40 controls the rate of the blowdown water leaving the system. Preferably, a flow meter 42 is used in conjunction with the valve 40 in order to facilitate accurate readings of the cooling tower's water balances and usage.

An important feature and advantage of the water treatment and management system of the present invention is the ability to track the system's performance. Performance of the cooling system is measured and/or reported by a monitor and control system 44, which comprises computer software used for substantially continuous monitoring and control of key and/or desired system parameters and water treatment equipment. Measurement is accomplished by intake and analysis of the sidestream 46 into the monitor and control system 44, which discharges the analyzed sidestream 48 for mixture with the circulating water 12.

Note that the sidestream 46 of circulating water 12 is pulled off at a junction upstream of the scale control unit 34 and downstream of the pump 32, whereas discharge occurs upstream of the pump 32 and downstream of the bio-control unit 28. These takeoff and discharge points are around the pump 32 so that there is a higher pressure on the downstream side that allows the water to flow through the sensor piping into the lower pressure suction side of the pump 32 to recapture the water back into the system.

In a preferred embodiment shown in FIG. 1, the monitor and control system 44 is designed to perform a variety of monitoring and control functions. For example, the monitor and control system 44 may maintain and/or control cycles of concentration by automatic conductivity-based bleed. The ratio of the concentration of solids in the cooling water to that in the makeup water is called the cycles of concentration (COC). Operating at higher cycles of concentration reduces the amount of blowdown, or bleed, required and, therefore, reduces the amount of water used in the cooling system. Limiting the COC helps to prevent scale formation also.

In addition, the monitor and control system 44 allows for monitoring, logging and archiving of specific water quality parameters and/or tower water balances and usage. Flow meters 18, 24, 42, in particular, assist in the capability of monitoring tower water balances and usage. The system 44 may also monitor, control and provide one or more alarms concerning treatment components and conditions, as well as allow for remote calibration of sensors and meters.

Additionally, the monitor and control system 44 is capable of performing corrosion monitoring, an integral feature that proactively determines the cooling system's corrosion control effectiveness. For instance, the system 44 may perform instantaneous corrosion rate measurements, such as through an online linear polarization-resistance (LPR) meter. The monitor and control system 44 may also monitor the cooling system's metallic corrosion rates, via corrosion coupons installed in a corrosion coupon rack, an arrangement that may produce more accurate readings over time than a LPR meter.

The monitoring aspect of the monitor and control system 44 is accessible on-site or remotely to view real time operation, access archived data and/or to manipulate system controls and setpoints. If an alarm condition is reached in the system 44, in one embodiment a monitor may be paged automatically for timely rectification of the situation.

As previously indicated, information collected and/or maintained by the system 40 is used to track the performance of a water management program as well as to highlight areas that could be further improved. This information or data may also be used as a way of documenting desired or key system parameters and/or the overall operation of the cooling water treatment program. This documentation may be presented to a customer on a regular basis and the overall operation of the cooling water treatment program. The various monitoring and reporting tools are among the important features and advantages of the present invention, that also assist in developing a more efficient cooling water treatment 5 system.

While there is no single component for addressing the control of corrosion, each of the previously described components contributes to corrosion control. For example, the scale control unit 34 assists in addressing corrosion by maintaining the cooling water in a stable non-corrosive alkaline pH range without any adjustments. The non-corrosive alkaline pH also helps to promote the desired formation of the mineral crystals within the water column instead of on heat exchange surfaces. Furthermore, these suspended scale crystals provide a thin, non-adhering corrosion buffer on all the metallic surfaces throughout the system.

The ionization bio-control unit 28 operates to substantially ensure that harmful bacteria, algae, slime and other microbiological activity in the cooling system remain under control at all times. This is accomplished by injecting into the cooling system low levels of copper and silver ions, which are highly effective against a wide range of microorganisms, including algae, biofilms and bacteria. By controlling these microbiological populations within the system, additional causes of corrosion are eliminated.

Moreover, the copper and silver ions produced by the bio-control unit 28 are effective at controlling and/or eliminating populations of various forms of microbiological life, as well as eliminating resilient biofilm, which harbors bacteria responsible for Microbiological Influenced Corrosion (MIC). Unlike traditional chemicals used to combat these microbiological issues (particularly oxidizers) that are often highly corrosive themselves, the ionization bio-control unit 28 of the present invention achieves superior control of these corrosion-causing microorganisms without the need for additional corrosion control.

Finally, efficient filtration, via the high-efficiency filtration unit 22 removes, on a substantially continuous basis, airborne debris scrubbed from the air by the water in the cooling tower. This debris provides nutrients that help support microbiological—life and aid in causing solid fouling, which promotes deposit formation and further corrosion. The filtration unit 22 also removes many of the solid particles formed by the scale control unit 34 that becomes suspended in the cooling water, further reducing the potential for fouling and corrosion. As previously indicated, the filtration unit 22 may be optional.

Together, the combined effects of these components not only limit corrosion within a cooling water system, but also keep the water clean, safe and crystal clear. When coupled with the microprocessor-based monitoring and control program 44, equipment used in cooling the water is reasonably well protected from corrosion.

Referring now to FIG. 2, there is shown another embodiment of the present invention with two variations from the preferred embodiment illustrated in FIG. 1, wherein like reference numerals indicate like elements. The two variations each concern the location of the monitor and control system 44, and the existence and/or location of one or more sidestreams. The variations shown are mutually exclusive and may be applied individually to the embodiment in FIG. 1.

The first alternative is locating the monitor and control system 44 within the same sidestream with the filtration unit 22 and ionization bio-control unit 28, rather than configuring the monitor and control system 44 with its own sidestream. In the arrangement depicted in FIG. 2, the sidestream flow is caused by an additional pump in the filtration unit 22 or, alternatively, elsewhere in sidestream, rather than using the motive force of the main cooling water circulating pump 32, as discussed earlier. Here, the monitor and control system 44 is preferably located upstream of the scale control unit 5, 34, 38 and heat exchanger apparatus 36, so that it most nearly samples the water conditions of the bulk cooling water 12.

The second alternative is the existence and/or location of the sidestreams. As depicted, the source supply is the heated water downstream of the heat exchanger 36 and upstream of the cooling tower 10. As described earlier, this configuration is less desirable than using the cooler water but can be employed nonetheless.

Referring now to FIG. 3, there is shown yet another embodiment of the present invention whereupon all of the treatment components are located within one sidestream 100 of the main cooling water piping. As before, this sidestream 100 requires its own pump 110 so that the sidestream water can return to essentially the same location from where it was supplied.

In the embodiment shown in FIG. 3, two sidestream alternatives 120, 130 are shown: the sidestream 120 located on the cooler side between the cooling tower 10 and the heat exchanger 36; and the other sidestream 130 located on the heated side between the heat exchanger 36 and the cooling tower 10.

The primary modification from the embodiments illustrated in FIGS. 1 and 2 is the location of the scale control unit 34 between or within the sidestreams 120, 130 as to the other treatment components. Therefore, the scale control unit 34 treats a smaller flow rate than when it is located on the main circulating water piping.

In the arrangement depicted in FIG. 3, scale control unit 34 supplies an adequate supply of viable nuclei to the main circulating flow (i.e. circulating water 12) and also acts more as a sidestream softener when coupled to the downstream filtration unit 22. This coupling is effective at reducing water hardness, or concentration of scale-forming minerals, by filtering them out immediately after they are formed.

The advantage of this embodiment is that substantially all the treatment components 44, 22, 34, 28 may be physically packaged together, such as on a skid, so that much of the interconnectivity between the components 44, 22, 34, 28 may be factory installed and/or tested. Thus, the bleed or blowdown valve 40 and flow meter 42 may be configured in substantially direct connection to the monitor and control system 44, rather than as a pull off from the circulating water 12.

If the sidestream pulloff for the valve 40 was located downstream of the heat exchanger 30 (i.e. used heated water), there would be no impact to the system operation. In other words, the blowdown water is hot which is preferred. If cold water downstream of the cooling tower 10 were used as the source for the sidestream, there would be a small impact to the thermal efficiency of the cooling water system. In other words, the blowdown water is cold. This has a small impact in that the cooling tower has just cooled the hot water and a small blowdown stream, now cooled is leaving the system without having been used to cool a heat exchanger.

Referring now to FIG. 4, there is shown a slight modification of the embodiment illustrated in FIG. 3. This arrangement in FIG. 4 is substantially identical to the one shown in FIG. 3, except that the location of the sidestream supply and return.

More specifically, a small piping network is constructed and installed within the collection basin 160 of cooling tower 10. Cooling water is removed from the basin, flows through the entire sidestream 140, 150 and is returned to the same basin 160, albeit at another location. One reason for using the basin 160 as the same supply and return location of the sidestreams 140, 150 is to promote effective removal of collected debris or suspended solids from the basin 160 so that collected debris may be filtered out in the sidestreams 140, 150. This has the added benefit of continually cleaning the collection basin 160 of cooling tower 10.

Another important advantage to this arrangement is that the piping for the circulating water 12 need not be altered in order to install the treatment equipments 28, 44, 34, 22. With all of the previous embodiments, each sidestream requires that taps be made into the circulating piping during installation. This often requires undesirable shutdown and potential draining of the circulating cooling water 12 for a period of time. Neither undesirable situation is necessary with a sidestream treatment flowing in and out of the collection basin 160 of cooling tower 10.

The above description and drawings are only illustrative of preferred embodiments that achieve the objects, features and advantages of the present invention, and it is not intended that the present invention be limited thereto. Any modification of the present invention that comes within the spirit and scope of the above description is considered to be part of the present invention.

1. An apparatus for non-chemical treatment and management of cooling water, comprising:
at least one scale control unit; and
at least one ionization bio-control unit.

2. An apparatus as claimed in claim 1, further comprising;
a filtration unit;

3. An apparatus as claimed in claim 1, further comprising:
a cooling water monitoring and control system.

4. An apparatus as claimed in claim 1, wherein said cooling water monitoring and control system is microprocessor-based.

5. An apparatus as claimed in claim 1, wherein said at least one scale control unit is electronic.

6. An apparatus as claimed in claim 1, further comprising:
at least one flow meter.

7. An apparatus as claimed in claim 1, further comprising:
a heat exchanger.

8. An apparatus as claimed in claim 1, wherein said filtration unit removes particulate matter having a size substantially ten microns and higher.

9. An apparatus as claimed in claim 3, wherein said filtration unit is located downstream from said cooling water monitoring and control system.

10. An apparatus as claimed in claim 7, wherein said filtration unit is located upstream from said heat exchanger.

11. An apparatus as claimed in claim 1, wherein said at least one ion ionization bio-control unit is capable of generating silver and copper ions.

12. An apparatus as claimed in claim 1, wherein said at least one ion ionization bio-control unit is located downstream from said filtration unit.

13. An apparatus as claimed in claim 7, wherein said at least one ion ionization bio-control unit is located upstream from said heat exchanger.

14. An apparatus as claimed in claim 3, wherein said cooling water monitoring and control system is located upstream from said at least one scale control unit.

15. An apparatus as claimed in claim 7, wherein said cooling water monitoring and control system is located upstream from said heat exchanger.
